(19) United States
(12) Patent Application Publication
(10) Pub. No.: US 2025/0321712 A1
(43) Pub. Date: Oct. 16, 2025

(54) Synchronization of Application Instances Using Pre-Generated Seeds

(71) Applicant: AIM Games, LLC, Henderson, NV (US)

(72) Inventors: Aletheia Dione O'Neil, Henderson, NV (US); Gerald Timothy O'Neil, Henderson, NV (US); Justin Parsons, Monroe, WA (US)

(21) Appl. No.: 19/172,872

(22) Filed: Apr. 8, 2025

Related U.S. Application Data
(60) Provisional application No. 63/632,132, filed on Apr. 10, 2024.

(51) Int. Cl. G06F 7/58; A63F 13/798

(52) U.S. Cl. CPC G06F 7/58; A63F 13/798

(57) ABSTRACT

A synchronized experience is provided by multiple client devices using a seed selected from a pool of pre-generated seeds. The client devices use a set of random numbers generated using the selected seed to provide the common synchronized experience. The pool of pre-generated seeds may be classified into groups such as difficulty levels and a seed for a given synchronized experience may be selected from a particular group to provide a synchronized experience with the corresponding classification.

### CROSS-REFERENCE TO RELATED APPLICATIONS

This application claims the benefit of U.S. Provisional Patent Application No. 63/632,132, filed Apr. 10, 2024, which is incorporated by reference.

### BACKGROUND

### 1. Technical Field

The subject matter described relates generally to synchronized applications and, in particular, to the use of pre-generated random number seeds to synchronize an experience across multiple application instances.

### 2. Background Information

Many modern applications use a client server architecture where application functionality is provided to users at their client device and coordinated for multiple client devices by a server. In some such applications, random or pseudorandom numbers (collectively referred to in this disclosure as random numbers for convenience) are used to provide variations in experiences provided to users. For example, in a meditation application, random numbers may be used to provide variations in audio visual content presented to aid the user in entering the desired state of mind. As another example, in a card game application, random numbers may be used to determine the order of cards in one or more draw piles.

One existing approach to synchronization using random numbers generates a seed when an application experience is initiated and then generates a string of random numbers for controlling the experience using the seed. The seed may be generated using an identifier of the experience (e.g., an experience ID), a current time, or both. However, some problems arise from this approach. Because the seeds are generated when the experience is initiated, the application cannot have any a priori knowledge of the experience that will result from the seed. Some seeds may result in poor experiences, such as games that are too easy or too difficult, or that are not well aligned to the user, such as games that are of an inappropriate skill level for the particular user. Furthermore, it is challenging for the application provider to identify anomalous behavior (e.g., cheating in games) because it is difficult to decouple effects of the seed from user-caused aspects of the experience.

### SUMMARY

The above and other problems may be solved by using seeds selected from a pre-generated pool of seeds. The seeds can be classified using various approaches to indicate the type of the corresponding experience they provide. For example, seeds may be classified based on a classification of the resulting experience (e.g., low, medium, or high intensity, etc.). Alternatively, the classifications may be scores assigned to the seeds indicating a property of the resulting experiences (e.g., a difficulty score as a percentage or some other scale). In some embodiments, the initial classification of a seed may be determined by simulating the resulting experience and applying a set of rules to evaluate the experience. The initial classification may be updated based on results of or feedback on the resulting experiences provided by users. The classifications may be used for other tasks as well. For example, difficulty scores may be used to select a seed for users based on experience, determined skill level, or any other affinity metric based on properties of the user (e.g., as indicated in a user profile). As another example, difficulty scores may be compared to match scores to identify undesirable behavior (e.g., in a gaming application, if a match score is abnormally high in view of the difficulty score or match scores obtained by other players using the same seed, this may be indicative of cheating).

In one embodiment, a method for synchronizing an experience (e.g., a match in a skill-based game) between multiple client devices includes receiving requests to initiate synchronized experiences from a plurality of client devices and matching a set of the plurality of client devices. The set of client devices are provided with a common synchronized experience. The method also includes selecting a seed for the common synchronized experience from a pool of pre-generated seeds and providing the selected seed (or a set of random numbers generated using the selected seed) to the set of client devices. The set of client devices uses the set of random numbers generated using the selected seed to provide the common synchronized experience.

The method may also include identifying users associated with the plurality of client devices and retrieving properties of the users. The properties of the users may be used to match the set of client devices, select the seed, or both. The properties of the users may include at least one of: an experience level, a skill level, or a win-loss ratio.

In some embodiments, each seed has a classification that was generated by simulating a simulated synchronized experience provided using the seed and applying a set of rules to the simulated synchronized experience to generate the classification. The classification may be a difficulty of the synchronized experience that results from using the seed. The method may also include receiving feedback regarding the common synchronized experience from at least one of the set of client devices and updating the classification of the seed for the common synchronized experience based on the feedback. The feedback may be a score obtained in the synchronized experience relative to an expected score determined from the classification. The method may additionally include identifying that a user associated with one of the client devices engaged in cheating behavior in the synchronized experience based on the feedback.

### BRIEF DESCRIPTION OF THE DRAWINGS

FIG. 1 is a block diagram of a networked computing environment suitable for providing synchronized application experiences, according to one embodiment.

FIG. 2 is a block diagram of the server of FIG. 1, according to one embodiment.

FIG. 3 is a block diagram of a client device of FIG. 1, according to one embodiment.

FIG. 4 is a flowchart of a method for synchronizing an experience between multiple client devices, according to one embodiment.

FIG. 5 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise. Portions of the following description describes the use of seeds to provide synchronized experiences in various games (e.g., a solitaire or slot-based game), but it should be appreciated that the disclosed techniques may be used in any application where providing a synchronized experience is desirable.

### Example Systems

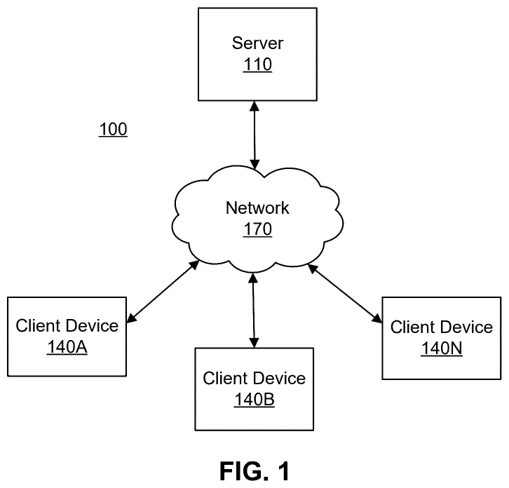

FIG. 1 illustrates one embodiment of a networked computing environment 100 suitable for providing a synchronized experience to multiple client devices. In the embodiment shown, the networked computing environment 100 includes a server 110 and multiple client devices 140. Although three client devices 140 are shown (a first client device 140A, a second client device 140B, and an Nth client device 140N), it should be appreciated that the networked computing environment 100 can include any number of such devices. In other embodiments, the networked computing environment 100 includes different or additional elements. In addition, the functions may be distributed among the elements in a different manner than described.

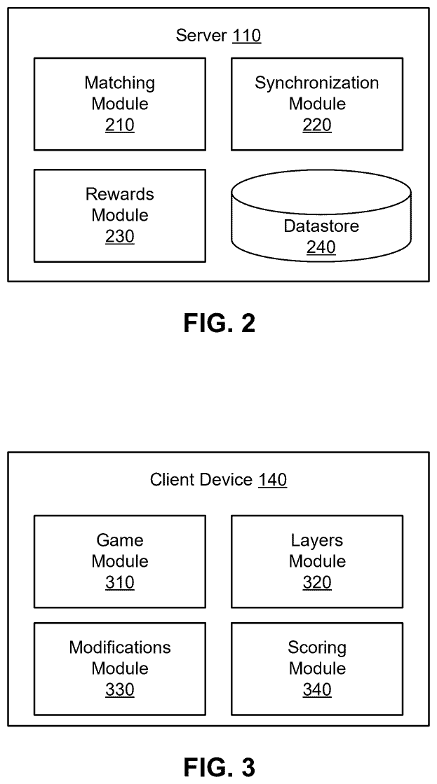

The server 110 is one or more computing devices that coordinate synchronized experiences. In one embodiment, the server 110 receives requests from client devices 140 of users to initiate synchronized experiences within an application, matches requests to form matchups, and synchronizes the instances of the application executing on each user's client device 140. The server 110 may also update user profiles based on activity during the synchronized experience. For example, in a gaming application, the server 110 may assign a reward to the winning player, update gameplay statistics (e.g., win and loss ratios) of the players, or update achievements earned by the players, etc. As another example, in a meditation application, the server 110 may update metrics for users such as total time spent meditating, consistency of breathing, reported changes in mood, and the like. Various embodiments of the server 110 are described in greater detail below, with reference to FIG. 2.

A client device 140 is a computing device with which a user can participate in a synchronized experience (e.g., a match of a game). The client device 140 can be a smartphone, laptop, desktop, tablet, or other personal computing device. Alternatively, the client device 140 may be a dedicated gaming machine (e.g., in a gaming arcade or casino). In one embodiment, the client device 140 provides a user interface (e.g., in a dedicated app or web browser) with which the user can request a synchronized experience. On receiving a matchup identifying one or more other players (e.g., from the server 110) and synchronization information, the client device 140 begins the synchronized experience. The user engages with the synchronized experience using the client device 140. In the example of a slot machine game, the user may play by initiating spins of a set of reels and choosing modifiers/power ups to apply. The results of the spins (and in some cases the power ups available) may be determined by random numbers generated from one or more seeds provided by the server 110. Thus, by providing the same seed to multiple players, equivalent matches can be provided meaning that the results are determined primarily by the skill of the player in making choices. At the end of the game, the player may be awarded one or more rewards based on the result of the game. Rewards may be virtual rewards, such as ranking points or virtual objects for display within the game or correspond to real-world rewards, such as entitling the player to claim cash or a physical prize. Various embodiments of client device 140 are described in greater detail below, with reference to FIG. 3.

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

FIG. 2 illustrates one embodiment of the server 110. In the embodiment shown, the server 110 includes a matching module 210, a synchronization module 220, a rewards module 230, and a datastore 240. In other embodiments, the server 110 includes different or additional elements. In addition, the functions may be distributed among the elements in a different manner than described. For example, rather than providing synchronization information to the client devices 140, the server 110 may determine the results of spins itself and provide the results of those spins to the client devices 140.

The matching module 210 groups users together for synchronized experiences (e.g., to compete in matches of a game). Note that the experiences are described as synchronized because they use a common seed to provide an experience at each client device 140 that would be the same for users that make the same choices/input. The experiences may not necessarily be chronologically synchronized, meaning the users may engage with the experiences at different times. In one embodiment, where the experience is a skill-based game, the matching module 210 receives requests initiated by players for matches (e.g., from client devices 140) and selects pairs of players to compete against each other in a match. Specifically, on receiving a request from a first player, the matching module 210 may retrieve information about the player (e.g., from a player profile stored in the datastore 240) and pair the first player with a second player that has similar player information. Player information may include metrics indicating the skill level of the player (e.g., win-loss record, a weighted skill score based on wins and losses and the skill level of the other players involved in those wins and losses, average score achieved, etc.), demographic information about the player, or a location of the player, etc. For example, the matching module 210 may pair players that have similar skill levels according to one or more skill level metrics to provide a challenging and engaging match for both players.

The synchronization module 220 synchronizes the application experience for all users participating in the experience. In one embodiment, the synchronization module 220 provides an ordered set of random or pseudorandom numbers generated from a common seed to the client device 140 of each user. Alternatively, the synchronization module 220 may provide the same seed to each client device 140 and a random or pseudorandom number generator on each client device 140 uses the seed to generate the same set of numbers as are generated by the other client devices using the seed. Each client device 140 then uses the ordered set of random numbers to drive the synchronized experience. For example, in a game, the ordered set of random numbers may be used to determine the results of each spin of reels, to determine what cards are drawn and in what order, or to determine a tile or block layout, etc., such that, if the players each made the same decisions in the game, they would experience identical gameplay. Thus, the results of the game are not driven by the random chance of the random numbers generated but rather by the decisions made by each player.

The seed used to generate random numbers may be selected from a pre-generated pool of seeds. Typically, the size of the pool is selected such that users do not receive the same seed frequently enough to notice repetitions. Each seed may be associated with a grade or classification indicating difficulty of the resulting match in a game, type of exercise in a meditation application, or any other classification that is appropriate for the specific type of application in which the synchronized experience occurs. In various embodiments, the grade or classification for a seed is initially assigned automatically using an analytical approach and then modified over time based on feedback received from actual experiences generated using the seed. For example, a collection of scores achieved by players in games generated using a seed may be provided to the server 110, which may update the grade or classification based on the mean, median, or another metric generated from the collection of scores (e.g., if players consistently achieve higher scores than expected given the initial grade or classification, the difficulty of the seed may be lowered while if players consistently achieve lower scores than expected, the difficultly may be increased). Thus, the grade or classification assigned to each seed may be refined over time based on the actual experience of players in games generated using the seeds.

In one embodiment, the initial difficulty assigned to a seed is determined by simulating the resulting games and applying a set of rules. For example, in a solitaire game, a tree of every possible move may be generated and the number of paths to a solve or the length of paths to a solve may be used to assign a difficulty to the seed. The length of a path may be linear (i.e., a number of moves required to reach the solve) or weighted (meaning that the length assigned to each move is based on how difficult or obvious the move is (as determined by a set of rules). For example, moves that are unusual or appear to take the game state away from a solve may be penalized, even if those moves actually provide the best path to a solve, to reflect the fact that a human is unlikely to make such moves. In some embodiments, a trained machine learning model may be used to assign difficulty scores to moves. As described previously, once the initial difficulty of a score has been calculated, it may be updated based on feedback about actual matches played using the seed (e.g., metrics calculated from actual scores achieved by players in games generate using the seed or player feedback provided on their subjective views on the difficulty of the game).

Using pre-generated seeds with assigned classifications or grades can provide various advantages over existing approaches. One such advantage is that it enables users to be provided with experiences that have a difficulty that is appropriate for their experience or skill level. When creating an experience, the server 110 may determine a desired difficulty for the experience based on user preferences, statistics of the users (e.g., win-loss ratios, metrics relating to breathing or heart rates in medication exercises, etc.), experience of the users (e.g., a total number of games played by the users. A total number of meditation exercises completed by the users, etc.), skill levels of the users (e.g., average scores or average scores relative to other players in games using the same seed of the players), or any other metric indicative of user experience or skill level. For example, low-difficulty seeds may be provided to first time users while high-difficulty seeds may be provided to users with total numbers of experiences completed or win-loss ratios (after a minimum number of games) above a threshold.

Another advantage of using pre-generated seeds is that it can provide a mechanism for identifying undesirable behavior such as cheating in a gaming application. Because, unlike in conventional approaches, the same seed can be used for multiple matches, expected distributions of scores can be determined. These expected distributions can be universal (i.e., for all players) or based on player experience/skill metrics (e.g., the average score obtained using the seed by players that have played over one hundred matches). The score obtained by a specific player relative to the distribution (and the player's profile, where the distribution depends on player experience/skill metrics) can be evaluated and flagged as potentially cheating behavior if the score is higher than a range of expected scores. This analysis may be performed for individual matches or aggregated over multiple matches (e.g., if a player scores above the expected range in a threshold percentage of their games, they may be flagged as potentially cheating). When a player is identified as potentially cheating, corrective action may be taken automatically (e.g., issuing a warning to the player or banning the player from the game) or the player may be identified to a human (e.g., an employee of the game provider) for further review.

In some embodiments, the synchronization module 220 provides more than one set of ordered random numbers to the client devices 140 of the users. This can provide an improved and more balanced experience in various circumstances. For example, a first set of random numbers may be used to determine the results of spins in regular rounds of a main game and a second set of random numbers may be used to determine the results in a bonus round or bonus spin. Thus, regardless of when players trigger the bonus round or spin, the results of spins in the main game will remain synchronized between players. It should be appreciated that, depending on the specific game design, there may be many different functions within the game for which it is advantageous to synchronize sets of random numbers across the client devices 140 of the players.

The rewards module 230 issues rewards to users for their performances in synchronized experiences, such as rewards for meeting certain metrics such as number of wins or total hours spent meditating, etc. Rewards may be issued to users by adding identifiers of the rewards earned to the user's profile (e.g., as stored in the datastore 240). In one embodiment of a gaming application, each player in a match pays virtual currency to enter the match and the rewards module 230 assigns the entrance fees of all players to the winner. Additionally or alternatively, players may be given other rewards for achieving various tasks, such as badges for completing a certain number of matches, having a winning streak of a predetermined length, beating a player ranked a certain amount above them, and the like. It should be appreciated that a wide range of reward distribution methods can be implemented depending on the specifics of the application design and the number of users involved in the synchronized experience. In some embodiments, some or all of the rewards may be exchanged by users for real world currency.

The datastore 240 is one or more non-transitory computer-readable media that store data used by the other components of the server 110. For example, the datastore 240 can store user profiles, payout tables for games, content for meditation exercises, identifiers and conditions for earning other rewards, or any other data used in association with providing synchronized experiences to client devices 140. Although the datastore 240 is shown as a single component within the server 240, the data may be stored across multiple storage media, some or all of which may be located remotely from the server 110 (e.g., as part of a distributed database).

FIG. 3 illustrates one embodiment of a client device 140 that provides a slot machine skill-based based game to players. In the embodiment shown, the client device 140 includes a game module 310, a layers module 320, a modifications module 330, and a scoring module 340. In other embodiments, the client device 140 includes different or additional elements. In addition, the functions may be distributed among the elements in a different manner than described.

The game module 310 provides the basic mechanics of the slot machine game. The game round module 310 causes the user interface of the slot machine game to be displayed on a screen of or connected to the client device 140. In one embodiment, the user interface includes a visual representation of a set of reels and a button to trigger the next spin the reels. The user interface may also include controls for applying and controlling the various layers and other modifications provided by the layers module 320 and modifications module 330, respectively. When the player triggers the button to spin the reel, the game module 310 obtains the next random or pseudorandom number in the set of numbers being used for synchronization set (e.g., as provided by the synchronization module 220) and applies the obtained number to select a position of the reel using the reel weights. For example, if the random number is an integer between one and ten and the reel has six positions with weights of 0.2, 0.2, 0.2, 0.2, 0.1, and 0.1, then if the random number is one or two, the first position is selected, if the random number is three or four, the second position is selected, etc., all the way up to if the random number is ten, the sixth position is selected.

The layers module 220 manages the application of layers to the reels by the player that impact the results of spins. In one embodiment, a layer is a data object that has a field for each position of one or more reels to which it is applied. A layer may be applied to a single reel or multiple reels. The content of each field defines how the corresponding position of a reel is modified by the layer. Examples of possible modifications performed by layers include replacing symbols of a first type with a second type, upgrading symbols of a specified type to a higher level, adding bonus points or other rewards to certain positions on the reel, changing the weights of the positions on the reel, and the like. It should be appreciated that a wide range of properties of the reels may be modified by applying layers.

What layers are available to a player can be determined by various aspects of the current game state. For example, all players may start a match with a certain set of layers available and decide how to make optimal use of them throughout the match. Additionally or alternatively, layers may become available to a player based on gameplay. For example, layers may be added to reel positions as bonus objects that are earned if that position comes up or that are earned if the player achieves certain objectives, such their total score reaching a target or the score of a single spin exceeding a threshold.

In some embodiments, modifications made by layers may be absolute (e.g., this position will have a particular symbol) or conditional (e.g., if this position has a first symbol, replace it with a second symbol). Conditional field values enable layers to combine in interesting ways. For example, a first layer might cause a particular symbol to appear at a given position on a reel and a second layer that upgrades all instances of the particular symbol can then upgrade the symbol at the given position, even where it would not upgrade that position if the first layer had not been applied. Note that the effects of layers do not have to be positive. In some embodiments, a layer may add a mix of positive and negative effects (e.g., replacing a first type of low value symbol with a first type of high value symbol while also replacing a second type of high value symbol with a second type of low value symbol), further increasing the challenge to the players in determining how to effectively apply the layers in the optimal combination.

Layers are generally added in a particular order and are applied sequentially in that order. In one embodiment, layers are applied in the order that the player added them, meaning the first layer added is the first one applied. Alternatively, the reverse order may be used, with the most recently added layer being applied first. In another embodiment, the player may choose where in the order to add a new layer to apply it with the greatest effect.

Layers may also include metadata providing conditions for when the layer is removed. This may depend on the particular layer. Some layers may remain for the rest of a match once added. Others may last for a predetermined number of spins. Yet others may last until they are triggered. For example, a layer that adds bonus points to a particular position on a reel may last until that position on the reel is selected in a spin (earning the player the bonus points) or the end of the match, whichever comes sooner. After each spin, the layers module 320 may evaluate the metadata of all applied layers and remove layers as appropriate.

The modifications module 330 provides additional tools with which the players can modify the state of the game. These tools are distinct from the layers in that they generally do not impact the configuration of the reels. As with layers, the tools available to players may include an initial set of tools, tools earned through gameplay, or a combination of both. In one embodiment, the tools made available to players include one or more of: a nudge tool that lets the player move the position of a reel one or more positions (up, down, or in either direction), a peek tool that lets the player see symbols on the reel at positions that would otherwise be offscreen (e.g., to inform the player whether using a nudge is worthwhile), a hold tool that enables the player to prevent one or more reels from spinning when the next spin is initiated, an undo tool that enables the player to undo one or more prior actions, and the like. The tools provided by the modifications module 330 may also include global modifiers to the game state, such as score multipliers, modifications to the pay table, adding one or more additional reels, adding one or more additional pay lines, and the like.

The scoring module 340 determines the score earned by the player at the end of each game round and at the end of a match. The slot machine game includes a “pay table” that indicates combinations of symbols that award points. Thus, effective use of layers and other tools may enable a skilled player to drastically improve their score over what would be obtained by random spins alone. The scoring module 340 reports the score of the player to the server 110 and may also receive the on-going score of the other player or players in the match so the player can keep track of how they are performing. At the end of the match, the scoring module 340 may present the results of the match to the player (e.g., by causing a summary of the math to be displayed) and indicate any rewards earned.

At various points in a match, a player may trigger a bonus round or minigame. This may occur at the same time for all players or individually for a player when they meet one or more criteria. For example, a player may trigger a bonus round based on making selections for layers and use of other tools in less than a threshold amount of time, reaching a threshold total score, exceeding a threshold score in a single game round, etc. It should be appreciated that a wide range of conditions may be used to trigger bonus rounds and a wide range of bonus rounds may be included in the slot machine game to enable the player to earn additional points. For example, a bonus round may include one or more spins of a set of bonus reels with different symbols and layers applied than the main game. As another example, a bonus round may be an entirely different type of game, such as trivia or a short card game in which the player may earn points that are added to their total score. On completing a bonus round, gameplay will generally return to the main game with the reels in the same state as when the bonus round is triggered (possibly with some bonus applied that was earned in the bonus round, such as an upgrade to the value of one or more symbols).

### Example Methods

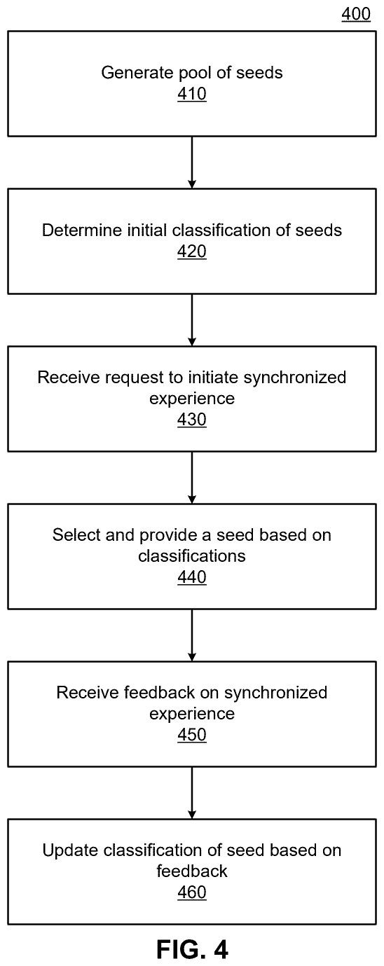

FIG. 4 illustrates a method 400 for synchronizing an experience between multiple client devices, according to one embodiment. The steps of FIG. 4 are illustrated from the perspective of the synchronization module 220 performing the method 400. However, some or all of the steps may be performed by other entities or components. In addition, some embodiments may perform the steps in parallel, perform the steps in different orders, or perform different steps.

In the embodiment shown, the method 400 begins with the synchronization module 220 receiving generating 410 a pool of random seeds. The synchronization module 220 may determine 420 an initial classification for at least some of the seeds. As described previously. The initial classification may be a difficulty score or classification (e.g., beginner, intermediate, advanced) calculated by simulating the experience (e.g., simulating a game) that results from use of a seed and applying rules to determine the difficulty. Additionally or alternatively, a machine-learning model may be trained on a set of human-labeled seeds/application states to predict the classifications of the synchronized experiences (e.g., the difficulties of games) generated by seeds that were not included in the training data.

The synchronization module 220 receives 430 a request to provide a synchronized experience (e.g., a match in a skill-based game) and selects 440 a seed based on the classifications of the seeds. For example, the seeds may be split into groups based on difficulty, a group may be selected based on one or more parameters (e.g., user preferences, user skill level, user experience, etc.) and then a seed may be randomly chosen from the selected group. The selected seed is provided to the client devices 140 associated with the users that will participate in the synchronized experience.

Once the synchronized experience has been provided to the users, the synchronization module 220 may receive 450 feedback regarding the experience from one or more of the users that participated. The feedback may be automatically generated (e.g., a score or other metric regarding the play or outcome of a game) or manually provided (e.g., a rating from one to ten on how hard the user perceived the match to be). The synchronization module 220 may then update 460 the classification of the seed based on the feedback. For example, if the players of a match scored higher than expected based on the difficulty assigned to the seed, the seed difficulty may be reduced while if the players performed worse than expected, the difficulty may be increased. It should be appreciated that a wide range of feedback may be provided and a wide range of corresponding modifications to seed classifications may be performed in response to that feedback, depending on the specific nature of the application and the synchronized experiences it provides.

### Computing System Architecture

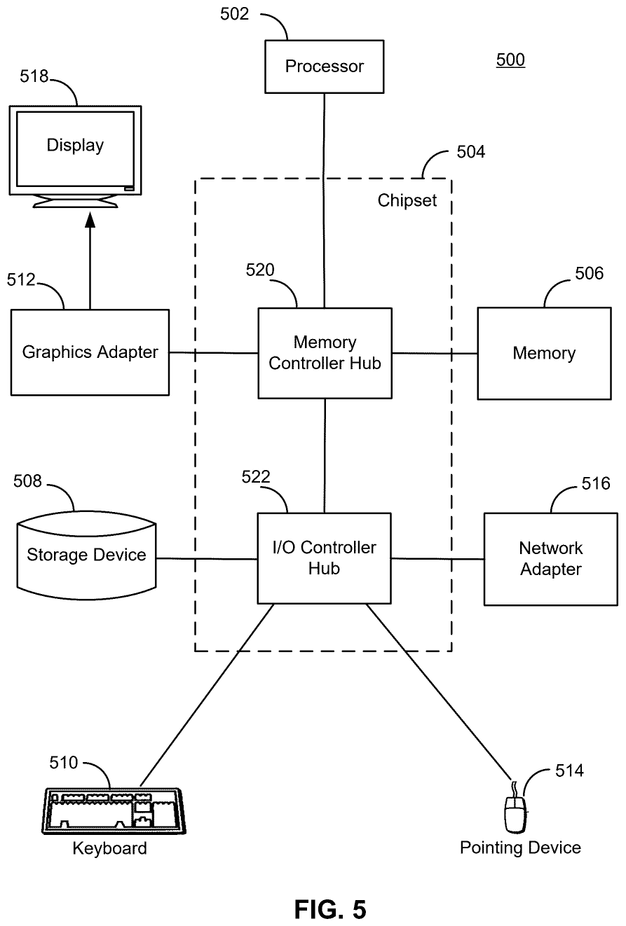

FIG. 5 is a block diagram of an example computer 500 suitable for use as a server 110 or client device 140. The example computer 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, keyboard 510, pointing device 514, and network adapter 516 are coupled to the I/O controller hub 522. Other embodiments of the computer 500 have different architectures.

In the embodiment shown in FIG. 5, the storage device 508 is a non-transitory computer-readable storage medium such as a hard drive, compact disk read-only memory (CD-ROM), DVD, or a solid-state memory device. The memory 506 holds instructions and data used by the processor 502. The pointing device 514 is a mouse, track ball, touchscreen, or other type of pointing device, and may be used in combination with the keyboard 510 (which may be an on-screen keyboard) to input data into the computer system 500. The graphics adapter 512 displays images and other information on the display 518. The network adapter 516 couples the computer system 500 to one or more computer networks, such as network 170.

The types of computers used by the entities of FIGS. 1 through 3 can vary depending upon the embodiment and the processing power required by the entity. For example, the server 110 might include multiple blade servers working together to provide the functionality described. Furthermore, the computers can lack some of the components described above, such as keyboards 510, graphics adapters 512, and displays 518.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for performing the same or similar functions as those disclosed above. Thus, while particular embodiments and applications have been illustrated and described, it is to be understood that the described subject matter is not limited to the precise construction and components disclosed. The scope of protection should be limited only by any claims that ultimately issue.

What is claimed is:

1. A method for synchronizing an experience between multiple client devices, the method comprising:
receiving requests to initiate synchronized experiences from a plurality of client devices;
matching a set of the plurality of client devices to which to provide a common synchronized experience;
selecting a seed for the common synchronized experience from a pool of pre-generated seeds; and
providing the selected seed or a set of random numbers generated using the selected seed to the set of client devices, wherein the set of client devices uses the set of random numbers generated using the selected seed to provide the common synchronized experience.

2. The method of claim 1, further comprising:
identifying users associated with the plurality of client devices; and
retrieving properties of the users, wherein matching the set of client devices is based on the properties of users associated with the set of client devices.

3. The method of claim 1, further comprising:
identifying users associated with the plurality of client devices; and
retrieving properties of the users, wherein selecting the seed is based on the properties of users associated with the set of client devices.

4. The method of claim 3, wherein the properties of the users include at least one of: an experience level, a skill level, or a win-loss ratio.

5. The method of claim 1, wherein the synchronized experience is a match in a skill-based game.

6. The method of claim 1, wherein each seed in the pool of pre-generated seeds has a classification, the classification of a given seed having been generated by a process comprising:
simulating a simulated synchronized experience provided using the seed; and
applying a set of rules to the simulated synchronized experience to generate the classification.

7. The method of claim 6, wherein the classification is a difficulty of a synchronized experience that results from using the seed.

8. The method of claim 6, further comprising:
receiving feedback regarding the common synchronized experience from at least one of the set of client devices; and
updating the classification of the seed for the common synchronized experience based on the feedback.

9. The method of claim 8, wherein the feedback is a score obtained in the synchronized experience relative to an expected score determined from the classification.

10. The method of claim 8, further comprising:
identifying that a user associated with one of the client devices engaged in cheating behavior in the synchronized experience based on the feedback.

11. A non-transitory computer-readable medium storing instructions for synchronizing an experience between multiple client devices, the instructions, when executed, causing a computing system to perform operations comprising:
receiving requests to initiate synchronized experiences from a plurality of client devices;
matching a set of the plurality of client devices to which to provide a common synchronized experience;
selecting a seed for the common synchronized experience from a pool of pre-generated seeds; and
providing the selected seed or a set of random numbers generated using the selected seed to the set of client devices, wherein the set of client devices uses the set of random numbers generated using the selected seed to provide the common synchronized experience.

12. The non-transitory computer-readable medium of claim 11, wherein the operations further comprise:
identifying users associated with the plurality of client devices; and
retrieving properties of the users, wherein matching the set of client devices is based on the properties of users associated with the set of client devices.

13. The non-transitory computer-readable medium of claim 11, wherein the operations further comprise:
identifying users associated with the plurality of client devices; and
retrieving properties of the users, wherein selecting the seed is based on the properties of users associated with the set of client devices.

14. The non-transitory computer-readable medium of claim 13, wherein the properties of the users include at least one of: an experience level, a skill level, or a win-loss ratio.

15. The non-transitory computer-readable medium of claim 11, wherein the synchronized experience is a match in a skill-based game.

16. The non-transitory computer-readable medium of claim 11, wherein each seed in the pool of pre-generated seeds has a classification, the classification of a given seed having been generated by a process comprising:
simulating a simulated synchronized experience provided using the seed; and
applying a set of rules to the simulated synchronized experience to generate the classification.

17. The non-transitory computer-readable medium of claim 16, wherein the classification is a difficulty of a synchronized experience that results from using the seed.

18. The non-transitory computer-readable medium of claim 16, wherein the operations further comprise:
receiving feedback regarding the common synchronized experience from at least one of the set of client devices; and
updating the classification of the seed for the common synchronized experience based on the feedback.

19. The non-transitory computer-readable medium of claim 18, wherein the feedback is a score obtained in the synchronized experience relative to an expected score determined from the classification.

20. The non-transitory computer-readable medium of claim 18, wherein the operations further comprise:
identifying that a user associated with one of the client devices engaged in cheating behavior in the synchronized experience based on the feedback.
